(19) United States
(12) Patent Application Publication
(10) Pub. No.: US 2020/0266736 A1
(43) Pub. Date: Aug. 20, 2020

(54) MOTOR CONTROL DEVICE, MOTOR CONTROL METHOD, MOTOR CONTROL PROGRAM, AND ACTUATOR

(71) Applicant: NABTESCO CORPORATION, Tokyo (JP)

(72) Inventors: Takashi OGAWA, Tokyo (JP); Takayuki JINNO, Tokyo (JP); Kento KUMAZAWA, Tokyo (JP)

(21) Appl. No.: 16/789,758

(22) Filed: Feb. 13, 2020

(30) Foreign Application Priority Data
Feb. 14, 2019 (JP) 2019-024698

(51) Int. Cl. H02P 6/18; H02P 6/06; H02P 6/08; H02P 6/28

(52) U.S. Cl. CPC H02P 6/18; H02P 6/28; H02P 6/08; H02P 6/06

(57) ABSTRACT

A motor control device includes: a current position detector that detects a current position of a driven object driven by an external motor; a position comparator that compares the current position of the driven object with a target position; a speed controller that subjects the motor to speed control based on a target speed of the driven object; a position controller that subjects the motor to position control based on the target position of the driven object; and a control switcher that switches control of the motor from the speed control to the position control when a difference between the current position and target position of the driven object becomes smaller than a predetermined threshold value.

### CROSS REFERENCE TO RELATED APPLICATION

The present invention claims priority under 35 U.S.C. § 119 to Japanese Application No. 2019-024698 filed Feb. 14, 2019, the entire content of which is incorporated herein by reference.

### BACKGROUND OF THE INVENTION

### 1. Field of the Invention

The present invention relates to a motor control device, a motor control method, a motor control program, and an actuator.

### 2. Description of the Related Art

Electromechanical actuators (EMA) that are driven by a motor have been developed as actuators for actuating, for example, rotating blades of aircraft to replace hydraulic actuators driven by hydraulic pressure.

[Patent literature 1] JP2015-104291

Motors for driving electromechanical actuators (hereinafter, simply referred to as “actuator”) need be controlled to move the rod of the actuator from a given position to a different position within a period of time defined by the specification. An object that is driven by the motor and is moved accordingly will be referred to as “driven object” hereinafter. The position at which the driven object is started to be moved will be referred to as “start position”, the targeted post-movement position will be referred to as “target position”, the current position during the movement will be referred to as “current position”, the targeted speed will be referred to as “target speed”, and the current speed during the movement will be referred to as “current speed”.

The motor of the related-art actuator is controlled such that a target position is first given by a command, and the motor is stopped when the driven object reaches the target position. According to this control, the driven object can be moved to the target position accurately. Regarding the speed of the motor, however, internal control for ensuring that a predetermined speed or acceleration is not exceeded is performed by using a limiter, etc., but it is not possible to set a target speed from outside. In this case, a gap between the actual speed and the target speed is unavoidable. In the case of aircraft, in particular, the rotating blade includes a plurality of flaps, and the plurality of flaps are driven by different actuators. In this case, the above-described motor control cannot control the driving speed of each actuator from outside with the result that the motion of the plurality of flaps varies from each other.

Patent literature 1 discloses a motor control program used in a motor control device configured to be capable of switching from a synchronous operation mode in which an estimated speed or an estimated phase estimated based on information that can be acquired from the motor is not fed back to a position detection operation mode in which the estimated speed is fed back. According to the technology, it is possible to adjust the torque axis current of the motor in accordance with how heavy the load is. However, speed control required of actuator driving cannot be realized with this technology.

### SUMMARY OF THE INVENTION

The present invention addresses the above-described issue, and a general purpose thereof is to make it possible to move a driven object to a target position accurately and, at the same time, to set the speed of a motor from outside.

A motor control device according to an embodiment of the present invention includes: a current position detector that detects a current position of a driven object driven by an external motor; a position comparator that compares the current position of the driven object with a target position; a speed controller that subjects the motor to speed control based on a target speed of the driven object; a position controller that subjects the motor to position control based on the target position of the driven object; and a control switcher that switches control of the motor from the speed control to the position control when a difference between the current position and target position of the driven object becomes smaller than a predetermined threshold value.

Another embodiment of the present invention related to a motor control method. The method includes: acquiring a target position and target speed of a driven object driven by an external motor; acquiring a current position of the driven object; subjecting the motor to speed control based on the target speed of the driven object; subjecting the motor to position control based on the target position of the driven object; and comparing a difference between the target position and the current position with a predetermined threshold value and switching control of the motor from the speed control to the position control when the difference becomes smaller than the threshold value.

Another embodiment of the present invention relates to a non-transitory recording medium encoded with a motor control program. The program recorded in the recording medium includes computer-implemented modules including: a module that acquires a target position and target speed of a driven object driven by an external motor; a module that acquires a current position of the driven object; a module that subjects the motor to speed control based on the target speed of the driven object; a module that subjects the motor to position control based on the target position of the driven object; and a module that compares a difference between the target position and the current position with a predetermined threshold value and switches control of the motor from the speed control to the position control when the difference becomes smaller than the threshold value.

Another embodiment of the present invention relates to an actuator. The actuator includes: a motor; a current position detector that detects a current position of a driven object driven by the motor; a position comparator that compares the current position of the driven object with a target position; a speed controller that subjects the motor to speed control based on a target speed of the driven object; a position controller that subjects the motor to position control based on the target position of the driven object; and a control switcher that switches control of the motor from the speed control to the position control when a difference between the current position and the target position of the driven object becomes smaller than a predetermined threshold value.

Optional combinations of the aforementioned constituting elements, and replacement of constituting elements or implementations of the present invention in the form of methods, devices, programs, transitory or non-transitory recording mediums storing programs, and systems may also be practiced as optional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a functional block diagram of the speed control device according to the first embodiment;

FIG. 2 shows a time-dependent change of the position of the driven object;

FIG. 3 shows a time-dependent change of the speed of the driven object of FIG. 2;

FIG. 4 is a functional block diagram of the speed control device according to the second embodiment; and

FIG. 5 is a flowchart of a speed control method according to the third embodiment.

### DETAILED DESCRIPTION OF THE INVENTION

The invention will now be described by reference to the preferred embodiments. This does not intend to limit the scope of the present invention, but to exemplify the invention.

A description will be given of suitable embodiments of the present invention with reference to the drawings. Like numerals are used to represent like elements, members, and processes and a description will be omitted as appropriate.

### First Embodiment

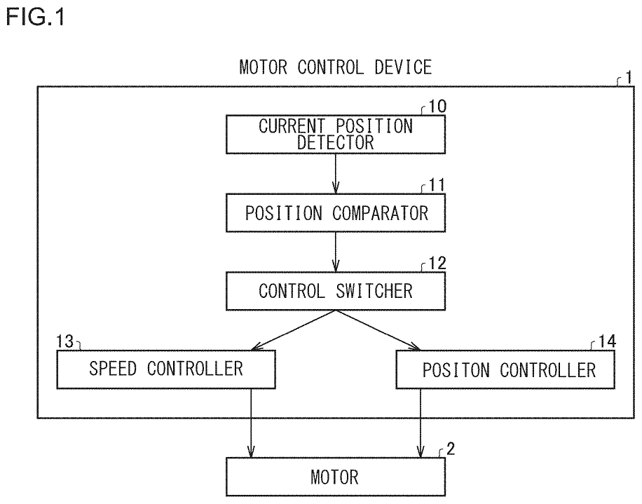

FIG. 1 is a functional block diagram showing a configuration of a motor control device 1 according to the first embodiment. The motor control device 1 includes a current position detector 10, a position comparator 11, a control switcher 12, a speed controller 13, and a position controller 14.

The current position detector 10 is comprised of a position sensor, etc. and detects the current position of the driven object (not shown) driven by an external motor 2. The current position detector 10 transmits the current position of the driven object thus detected to the position comparator 11.

The position comparator 11 stores the target position of the driven object. The position comparator 11 may store the target position by being provided with the target position by a command. The position comparator 11 compares the target position of the driven object thus stored and the current position of the driven object transmitted from the current position detector 10. The position comparator 11 transmits the difference between the target position and current position of the driven object to the control switcher 12.

The control switcher 12 stores a threshold value related to a difference between the target position and current position of the driven object (hereinafter, simply referred to as “threshold value”). The control switcher 12 compares the difference between the target position and current position of the driven object transmitted from the position comparator 11 with the threshold value. When the difference between the target position and current position of the driven object becomes equal to below the threshold value, the control switcher 12 switches the control of the motor 2 from speed control by the speed controller 13 to position control by the position controller 14.

The speed controller 13 controls the motor 2 since the motor 2 is started until the control is switched to position control. For example, the speed controller 13 accelerates the motor 2 from speed 0 to the target speed, and, after the motor 2 reaches the target speed, the speed controller 13 maintains the target speed.

When the control is switched to position control, the speed controller 13 stops controlling the motor 2.

The position controller 14 controls the motor 2 since the control switcher 12 switched the control until the motor 2 is stopped. For example, the position controller 14 decelerates the motor 2 gradually from the target speed, and, when the driven object reaches the target position, the position controller 14 stops the motor 2.

The position controller 14 stops controlling the motor 2 when the motor 2 is stopped.

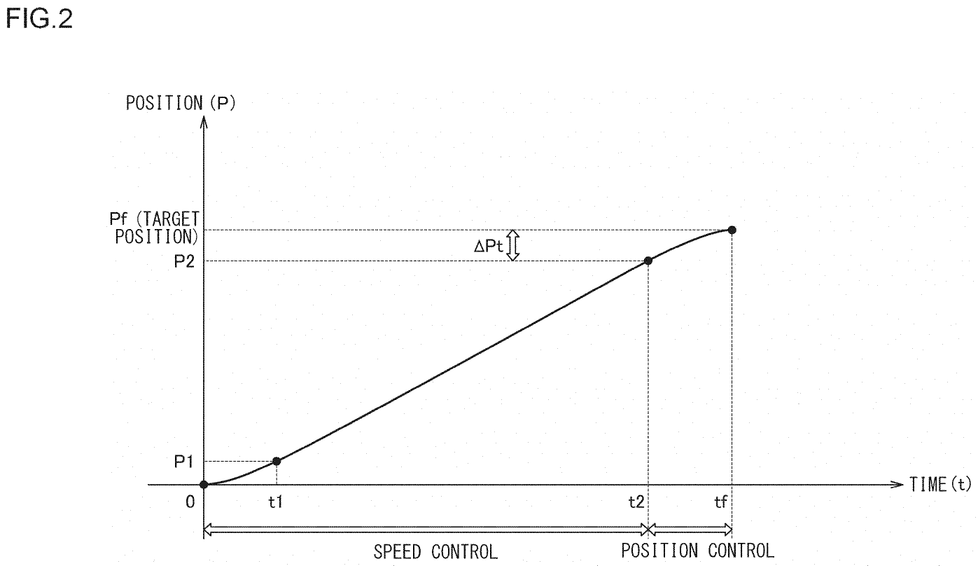

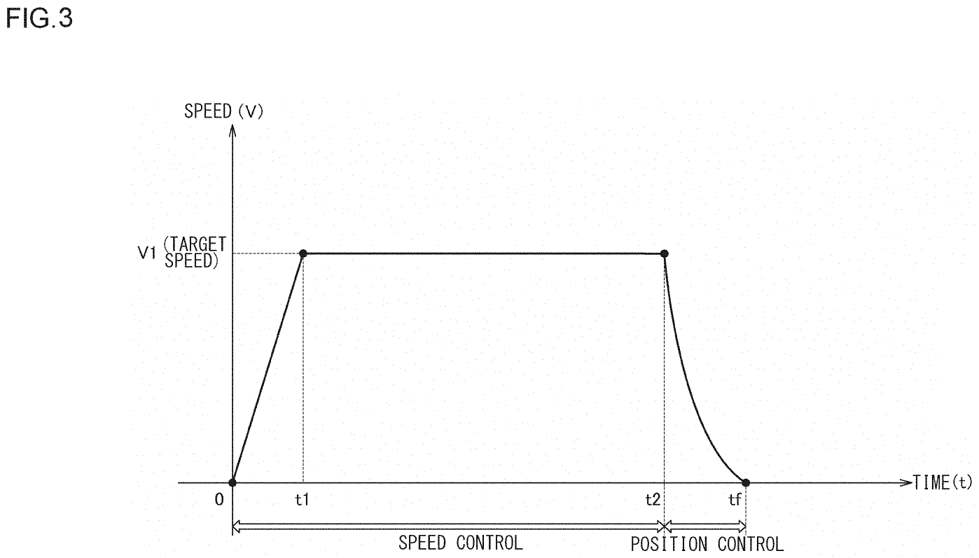

FIG. 2 shows a time-dependent change of position P of the driven object driven by the motor 2 controlled by the motor control device 1 of FIG. 1. FIG. 3 shows a time-dependent change of speed V of the driven object of FIG. 1. In other words, FIG. 3 shows the temporal differentiation of the function shown in FIG. 2.

Referring to FIG. 2, the driven object starts moving at t=0 from the start position P=0, arrives at P=P1 at t=t1, arrives at P=P2 at time t=t2, and arrives at the target position Pf at t=tf. The difference between the target position Pf and the position P2 matches the threshold value ΔPt at t=t2. Therefore, the motor 2 is controlled by the speed controller 13 while 0≤t≤t2 and controlled by the position controller 14 while t2≤t≤f.

Referring to FIG. 3, the speed controller 13 increases the speed of the driven object while 0≤t≤t1 at a constant acceleration (V1/t1). While t1≤t<t2, the speed controller 13 controls the motor 2 to maintain the target speed V1. In this process, the acceleration (V1/t1) may be controlled by a limiter, etc. so as not to exceed the upper limit defined by the specification, etc. While t2≤t<tf, the motor 2 is controlled by the position controller 14 so that the speed V of the driven object gradually decreases until it reaches 0 at t=tf. In this way, the motor is controlled to move the driven object at the target speed V1 while t1≤t<t2.

According to this embodiment, the driven object is actuated at a desired target speed for a predetermined period of time and, at the same time, the driven object can be moved to the target position accurately.

### Second Embodiment

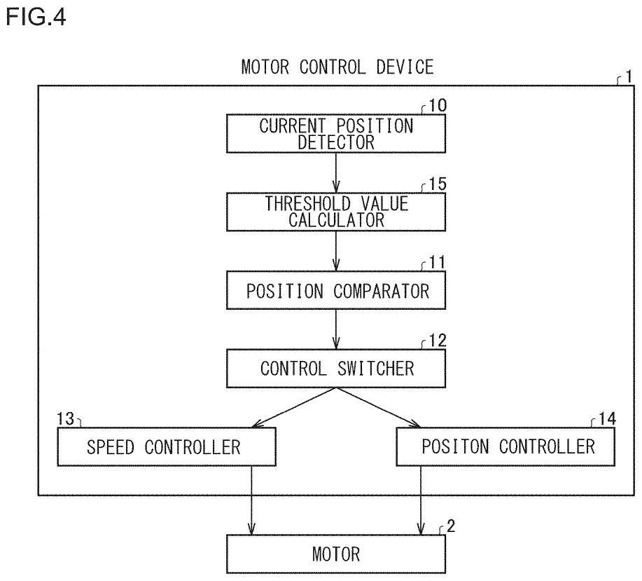

FIG. 4 is a functional block diagram showing a configuration of the motor control device 1 according to the second embodiment. In addition to the features of the motor control device of the first embodiment, the motor control device 1 is further provided with a threshold value calculator 15 for calculating a threshold value in accordance with a predetermined condition.

The threshold value may be calculated based on the target speed. For example, when the threshold value is too small for a given target speed, the motor cannot be stopped when the driven object reaches the target position even if position control is performed. As a result, the position reached by the driven object may be beyond the target position. To solve this problem, the threshold value calculator 15 may calculate the threshold value such that the higher the target speed, the larger the threshold value.

According to this embodiment, the driven object can be moved to the target position accurately.

The threshold value may be calculated based on the target position. For example, if a given target position is close to the limit of the range of movement of the driven object, the threshold value that is too small may cause the position reached by the driven object to be beyond the target position and the driven object may reach the limit of the range of movement. In other words, so-called bottoming may occur. To prevent this, the threshold value calculator 15 may calculate the threshold value such that the closer the target position to the limit of the range of movement of the driven object, the larger the threshold value.

According to this embodiment, the driven object can be moved to the target position accurately irrespective of the target position.

### Third Embodiment

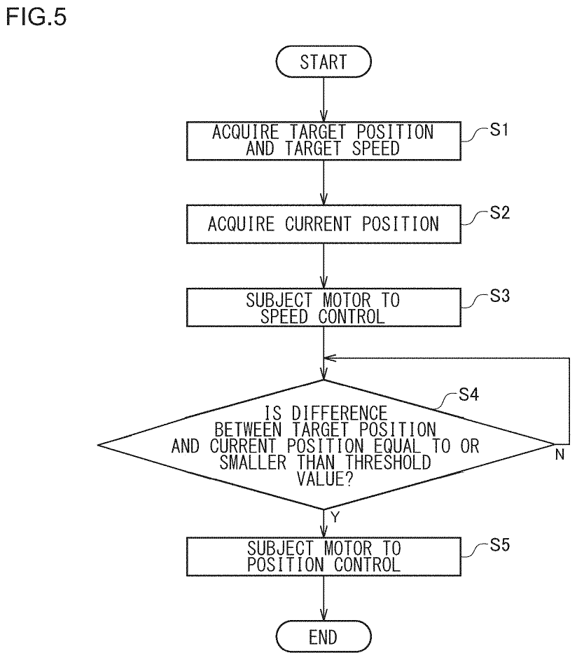

FIG. 5 is a flowchart of a speed control method according to the third embodiment. The method include step S1 of acquiring a target position and target speed of a driven object, step S2 of acquiring a current position of the driven object, step S3 of subjecting a motor to speed control, step S4 of comparing a difference between the target position and the current position and, when the difference is smaller than a threshold value, switching from speed control to position control to control the motor, and step S5 of subjecting the motor to position control.

In step S1, the method acquires the target position and target speed of the driven object. Predetermined values of the target position and target speed of the driven object may be given in advance. Alternatively, the values may be given by a human operator or an external device at a desired point of time.

In step S2, the method acquires the current position of the driven object. The current position of the driven object may be detected and given by a position sensor or the like.

In step S3, the method subjects the motor to speed control. For example, speed control of the motor may gradually decelerate the motor from the target speed, and, when the driven object reaches the target position, stop the motor.

In step S4, the difference between the target position and current position of the driven object is compared with the threshold value. When it is determined as a result of the comparison that the difference between the target position and current position of the driven object is equal to or smaller than the threshold value, speed control of the motor is switched to position control.

In step S5, the method subjects the motor to position control. For example, position control of the motor may gradually decelerate the motor from the target speed, and, when the driven object reaches the target position, may stop the motor.

According to this embodiment, the driven object is actuated at the desired target speed for a predetermined period of time and, at the same time, the driven object can be moved to the target position accurately.

Described above is an explanation based on an exemplary embodiment. The embodiments are intended to be illustrative only and it will be understood by those skilled in the art that variations and modifications are possible within the claim scope of the present invention and that such variations and modifications are also within the claim scope of the present invention. Therefore, the description in this specification and the drawings shall be treated to serve illustrative purposes and shall not limit the scope of the invention.

### (Variations)

A description will now be given of variations. In the description of the variations, constituting elements and members identical or equivalent to those of the embodiments shall be denoted by the same reference numerals. Duplicative explanations are omitted appropriately and features different from those of the embodiments will be highlighted.

### (Variation 1)

Instead of maintaining the target speed constant until the control is switched to position control, speed control may be such that the speed is decreased gradually in the latter half of the control. According to this variation, the speed is prevented from changing abruptly when the control is switched from speed control to position control.

### (Variation 2)

In the variation 1 described above, the acceleration of the driven object may be calculated based on the current speed occurring when position control is started. Speed control may be such that the speed is decreased in the latter half of the control so that the acceleration thus calculated is equal to or less than a predetermined value. According to this variation, the change in speed (acceleration) is prevented from becoming excessive when the control is switched from speed control to position control so that smooth switching of the control can be realized.

Any combination of the embodiment and a variation will also be useful as an embodiment of the present invention. A new embodiment created by a combination will provide the combined advantages of the embodiment and the variation as combined.

What is claimed is:

1. A motor control device comprising:
a current position detector that detects a current position of a driven object driven by an external motor;
a position comparator that compares the current position of the driven object with a target position;
a speed controller that subjects the motor to speed control based on a target speed of the driven object;
a position controller that subjects the motor to position control based on the target position of the driven object; and
a control switcher that switches control of the motor from the speed control to the position control when a difference between the current position and target position of the driven object becomes smaller than a predetermined threshold value.

2. The motor control device according to claim 1, further comprising:
a threshold value calculator that calculates the threshold value.

3. The motor control device according to claim 2, wherein
the threshold value calculator calculates the threshold value based on the target speed.

4. The motor control device according to claim 2, wherein
the threshold value calculator calculates the threshold value based on the target position.

5. The motor control device according to claim 3, wherein
the threshold value calculator calculates the threshold value based on the target position.

6. A motor control method comprising:
acquiring a target position and target speed of a driven object driven by an external motor;
acquiring a current position of the driven object;
subjecting the motor to speed control based on the target speed of the driven object;
subjecting the motor to position control based on the target position of the driven object; and
comparing a difference between the target position and the current position with a predetermined threshold value and switching control of the motor from the speed control to the position control when the difference becomes smaller than the threshold value.

7. A non-transitory recording medium encoded with a motor control program comprising computer-implemented modules including:
a module that acquires a target position and target speed of a driven object driven by an external motor;
a module that acquires a current position of the driven object;
a module that subjects the motor to speed control based on the target speed of the driven object;
a module that subjects the motor to position control based on the target position of the driven object; and
a module that compares a difference between the target position and the current position with a predetermined threshold value and switches control of the motor from the speed control to the position control when the difference becomes smaller than the threshold value.
